(19) United States
(12) Patent Application Publication
(10) Pub. No.: US 2026/0352078 A1
(43) Pub. Date: Nov. 5, 2026

(54) POWER GENERATING ELEMENT, POWER GENERATING MODULE, ROTATION SPEED DETECTOR, AND POWER GENERATOR

(71) Applicant: Mitsubishi Electric Corporation, Tokyo (JP)

(72) Inventors: Takeshi MUSHA, Tokyo (JP); Akira HOTTA, Tokyo (JP)

(73) Assignee: Mitsubishi Electric Corporation, Tokyo (JP)

(21) Appl. No.: 19/118,785

(22) PCT Filed: Oct. 21, 2022
(86) PCT No.: PCT/JP2022/039352

§ 371 Date: Apr. 7, 2025

(51) Int. Cl. H02K 35/02; G01P 3/487

(52) U.S. Cl. CPC H02K 35/02; G01P 3/487

(57) ABSTRACT

A power generating element includes: a plurality of magnetic wires having a large Barkhausen effect; a pickup coil wound around a bundle of the plurality of the magnetic wires; and magnetic connectors that magnetically connect ends of the plurality of the magnetic wires at both ends of the plurality of the magnetic wires, in which when a magnetic field applied to the magnetic wires is reversed, the magnetic wires generate a pulse voltage in the pickup coil by the large Barkhausen effect.

### FIELD

The present disclosure relates: to a power generating element including magnetic wires with a large Barkhausen effect and a pickup coil; and to a power generating module, a rotation speed detector, and a power generator including the power generating element.

### BACKGROUND

Conventionally, a power generating element including magnetic wires with a large Barkhausen effect and a pickup coil has been used in order to detect a rotation speed, which is the number of rotations per unit time of a motor, by self-power generation without requiring a battery or to operate an electronic device with electric power generated by micro vibration of a structure such as a bridge or machinery in a factory.

In the power generating element including the magnetic wires with the large Barkhausen effect and the pickup coil, the pickup coil is wound around the magnetic wires. Hereinafter, the power generating element including the magnetic wires with the large Barkhausen effect and the pickup coil is simply referred to as the power generating element. In the power generating element, when specific trigger magnetic field strength is exceeded, the direction of magnetization of the magnetic wires is quickly reversed due to the influence of an external magnetic field, and a voltage is generated in the pickup coil.

As the voltage generated in the pickup coil increases, the power generating element detects the rotation speed with higher accuracy. Also, as the voltage generated in the pickup coil increases, the power generating element can operate the electronic device having higher performance. Therefore, in the power generating element, it is required to increase the voltage generated in the pickup coil.

Patent Literature 1 discloses a power generating element in which a pickup coil is wound around at least two magnetic wires. In the power generating element disclosed in Patent Literature 1, the pickup coil is wound around the plurality of the magnetic wires, so that the voltage generated in the pickup coil when the trigger magnetic field strength is exceeded is higher than that in a power generating element including a single magnetic wire.

### CITATION LIST

### Patent Literature

Patent Literature 1: Japanese Translation of PCT International Application Laid-open No. 2022-519668

### SUMMARY OF INVENTION

### Problem to be Solved by the Invention

However, in the power generating element disclosed in Patent Literature 1, manufacturing variations of the magnetic wires result in small variations in the trigger magnetic field strength of the magnetic wires or small differences in the magnetic field applied from a magnet to the magnetic wires, which cause the timings of power generation to be off so that, assuming the number of the magnetic wires is N, the voltage generated in the pickup coil is lower than N times the voltage generated when one magnetic wire is used. Therefore, it is required to realize a power generating element that suppresses the voltage generated in the pickup coil from being reduced due to the manufacturing variations of the magnetic wires.

The present disclosure has been made in view of the above, and an object of the present disclosure is to provide a power generating element that suppresses a voltage generated in a pickup coil from being reduced due to manufacturing variations of magnetic wires.

### Means to Solve the Problem

In order to solve the above problem and achieve the object, a power generating element according to the present disclosure includes: a plurality of magnetic wires having a large Barkhausen effect; and a pickup coil wound around a bundle of the plurality of the magnetic wires. The power generating element includes magnetic connectors that magnetically connect ends of the plurality of the magnetic wires at both ends of the plurality of the magnetic wires.

### Effects of the Invention

The present disclosure can provide the power generating element that suppresses the voltage generated in the pickup coil from being reduced due to the manufacturing variations of the magnetic wires.

### BRIEF DESCRIPTION OF DRAWINGS

FIG. 1 is a perspective view illustrating a configuration of a power generating element according to a first embodiment.

FIG. 2 is a schematic graph illustrating an effect obtained by magnetically connecting ends of magnetic wires, at both ends thereof, in the power generating element according to the first embodiment.

FIG. 3 is a schematic graph illustrating an effect obtained by covering the both ends of the magnetic wires with magnetic tubes in the power generating element according to the first embodiment.

FIG. 4 is a perspective view illustrating a configuration of a power generating element according to a second embodiment.

FIG. 5 is a perspective view illustrating a configuration of a power generating module according to a third embodiment.

FIG. 6 is a perspective view illustrating a configuration of a rotation speed detector according to a fourth embodiment.

FIG. 7 is a plan view illustrating a magnet and a power generating element included in the rotation speed detector according to the fourth embodiment.

FIG. 8 is a perspective view illustrating a configuration of a power generator according to a fifth embodiment.

FIG. 9 is a perspective view illustrating a configuration of a power generating element included in a stator of the power generator according to the fifth embodiment.

### DESCRIPTION OF EMBODIMENTS

Hereinafter, a power generating element, a power generating module, a rotation speed detector, and a power generator according to embodiments will be described in detail with reference to the drawings.

### First Embodiment

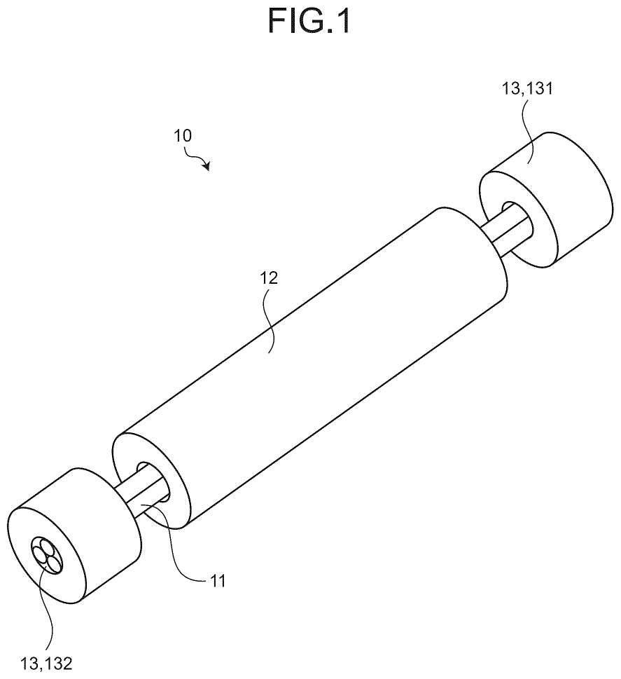

FIG. 1 is a perspective view illustrating a configuration of a power generating element according to a first embodiment. A power generating element 10 according to the first embodiment includes a plurality of magnetic wires 11 having a large Barkhausen effect, a pickup coil 12 wound around a bundle of the magnetic wires 11, and magnetic connectors 13 disposed at both ends of the magnetic wires 11. The magnetic connector 13 includes a magnetic tube 131 and a resin sealer 132 with which the inside of the magnetic tube 131 is filled.

The magnetic wire 11 has a magnetostrictive effect, and expands and contracts by magnetostriction in response to a change in an applied magnetic field.

The magnetic tube 131 is a tubular body formed of a soft magnetic material such as iron. The permeability of the magnetic tube 131 need only be higher than that of air, but is desirably higher than that of the magnetic wire 11, The soft magnetic material may be a steel material such as SS400 or S45C, a magnetic stainless-steel material such as SUS430 or SUS440, a high-permeability material such as permalloy or permendur, or the like. In the power generating element 10, the wider a distance between the magnetic tubes 131, the larger a magnetization reversal region of the magnetic wires 11, which results in an increase in the amount of power generated, Therefore, it is desirable that one of two of the magnetic tubes 131 is disposed at one end of the magnetic wires 11 or at a position as close as possible to the one end, and the other of the two magnetic tubes 131 is disposed at the other end of the magnetic wires 11 or at a position as close as possible to the other end.

The resin sealer 132 has hardness that does not hinder expansion and contraction of the magnetic wires 11 due to magnetostriction. The resin sealer 132 fixes the magnetic wires 11 in a state where the ends of the magnetic wires 11 are in contact with the magnetic tube 131. Therefore, the ends of the magnetic wires 11 are magnetically connected to each other.

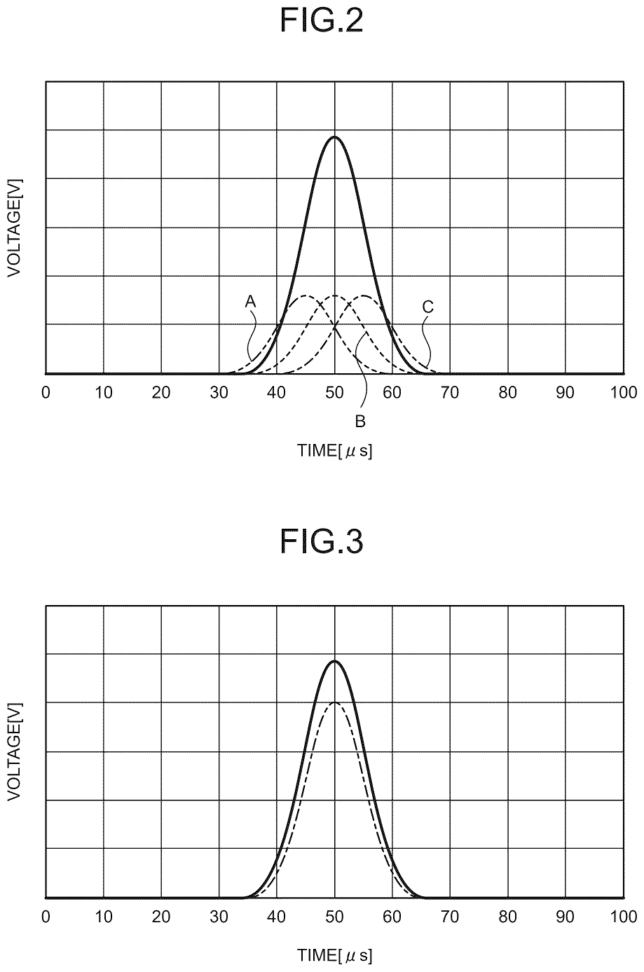

FIG. 2 is a schematic graph illustrating an effect obtained by magnetically connecting the ends of the magnetic wires, at the both ends thereof, in the power generating element according to the first embodiment. FIG. 2 schematically illustrates waveforms of voltages generated in the pickup coil 12 in a case where the ends of three of the magnetic wires 11 are not magnetically connected to one another at both ends thereof and a case where the ends are magnetically connected to one another. In FIG. 2, the vertical axis represents voltage, and the horizontal axis represents elapsed time from a certain reference time. Moreover, in FIG. 2, a broken line, a dash-dot line, and a dash-dot-dot line represent the waveforms of the voltages in the case where the ends of the three magnetic wires 11 are not magnetically connected to one another at the both ends thereof, and a solid line represents the waveform of the voltage in the case where the ends of the three magnetic wires 11 are magnetically connected to one another at the both ends thereof. In the case where the ends of the three magnetic wires 11 are not magnetically connected to one another at the both ends thereof, manufacturing errors of the magnetic wires 11 result in small variations in the trigger magnetic field strength of the magnetic wires or small differences in the magnetic field applied from a magnet to the magnetic wires, which cause variations in the timing of power generation of the magnetic wires 11. Here, when characteristics of the three magnetic wires 11 are distinguished as A, B, and C, the three magnetic wires 11 just being bundled together normally generate voltages in the pickup coil 12 at different timings. In an example illustrated in FIG. 2, the time when the voltage generated in the pickup coil 12 by the magnetic wire 11 having the characteristic A is the maximum and the time when the voltage generated in the pickup coil 12 by the magnetic wire 11 having the characteristic C is the maximum are off by 10 [μs], and the voltage obtained by superimposing the voltages generated in the pickup coil 12 by the three magnetic wires 11 is not a voltage three times the voltage generated in the pickup coil 12 by each of the three magnetic wires 11. On the other hand, in the case where the ends of the magnetic wire 11 having the characteristic A, the magnetic wire 11 having the characteristic B, and the magnetic wire 11 having the characteristic C are magnetically connected to one another at the both ends thereof, as represented by the waveform indicated by the solid line in FIG. 2, the timings of power generation of the magnetic wire 11 having the characteristic A, the magnetic wire 11 having the characteristic B, and the magnetic wire 11 having the characteristic C are aligned so that a high voltage is generated in the pickup coil 12 as compared with the case where the three magnetic wires 11 are not bundled together.

FIG. 3 is a schematic graph illustrating an effect obtained by covering the both ends of the magnetic wires with the magnetic tubes in the power generating element according to the first embodiment. FIG. 3 schematically illustrates waveforms of measurement results of voltages generated in the pickup coil 12 in a case where the both ends of the magnetic wires 11 are covered with the magnetic tubes 131 and a case where the both ends are not covered with the magnetic tubes 131. In FIG. 3, the vertical axis represents voltage, and the horizontal axis represents elapsed time from a certain reference time. Moreover, in FIG. 3, a dash-dot line represents the waveform of the voltage in the case where the both ends of the magnetic wires 11 are not covered with the magnetic tubes 131, and a solid line represents the waveform of the voltage in the case where the both ends of the magnetic wires 11 are covered with the magnetic tubes 131. As illustrated in FIG. 3, in the case where the both ends of the magnetic wires 11 are covered with the magnetic tubes 131, the voltage generated in the pickup coil 12 is higher than that in the case where the both ends of the magnetic wires 11 are not covered with the magnetic tubes 131. The reason why the voltage generated in the pickup coil 12 can be increased by covering the both ends of the magnetic wires 11 with the magnetic tubes 131 is presumed to be that the magnitude of the diamagnetic field is reduced by all of the plurality of the magnetic wires 11 being in contact with the magnetic tubes 131.

In addition, it has been confirmed that when the both ends of the magnetic wires 11 are firmly fixed, the voltage generated in the pickup coil 12 is reduced. This is presumably because when the both ends of the magnetic wires 11, having the magnetostrictive effect and expanding and contracting due to magnetostriction in response to a change in the applied magnetic field, are firmly fixed, the expansion and contraction of the magnetic wires 11 is hindered so that a magnetic change is inhibited, the magnetization reversal does not occur easily, and the voltage of power generated is reduced. In the power generating element 10 according to the first embodiment, the inside of the magnetic tube 131 is filled with the resin sealer 132, and the resin sealer 132 is present between the magnetic wires 11 and the magnetic tube 131, As described above, since the resin sealer 132 has the hardness that does not hinder the expansion and contraction of the magnetic wires 11 due to magnetostriction, the expansion and contraction of the magnetic wires 11 due to magnetostriction is not hindered by the resin sealer 132 so that a reduction in the voltage generated in the pickup coil 12 can be suppressed.

In the power generating element 10 according to the first embodiment, the ends of the magnetic wires 11 are magnetically connected to one another by the magnetic connector 13 including the magnetic tube 131 and the resin sealer 132, whereby it is possible to suppress the voltage generated in the pickup coil 12 from being reduced due to manufacturing variations of the magnetic wires 11.

### Second Embodiment

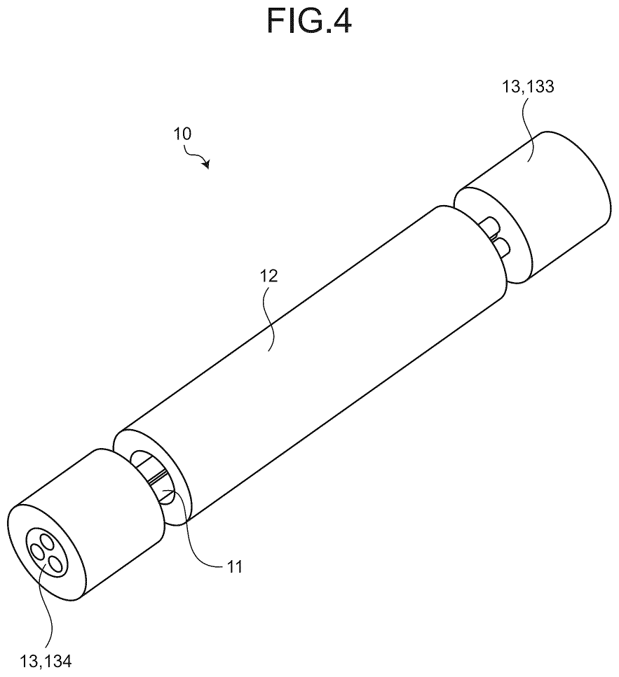

FIG. 4 is a perspective view illustrating a configuration of a power generating element according to a second embodiment. As with the power generating element 10 according to the first embodiment, the power generating element 10 according to the second embodiment includes the plurality of the magnetic wires 11, the pickup coil 12 wound around the bundle of the magnetic wires 11, and the magnetic connectors 13 disposed at the both ends of the magnetic wires 11. Note, however, that the magnetic connectors 13 include tubes 133 that cover corresponding ones of the both ends of the magnetic wires 11, and magnetic resin sealers 134 with which the insides of the tubes 133 are filled. Note that the tube 133 may be a non-magnetic material. Also, in the power generating element 10 according to the second embodiment, the plurality of the magnetic wires 11 are disposed with space thereamong.

The magnetic resin sealer 134 is a composite resin material in which magnetic powder as a dispersoid is dispersed in a resin as a dispersion medium. The magnetic resin sealer 134 has hardness that does not hinder expansion and contraction of the magnetic wires 11 due to magnetostriction. The magnetic resin sealer 134 is present between the magnetic wires 11 and the tube 133, and among the magnetic wires 11. Therefore, the ends of the magnetic wires 11 are magnetically connected to one another by the magnetic resin sealer 134. Since the magnetic wires 11 are disposed with space thereamong, only the both ends thereof are magnetically connected to one another, and portions other than the both ends are not in contact with one another.

In the power generating element 10 according to the second embodiment, the ends of the magnetic wires 11 are magnetically connected to one another by the magnetic connector 13 including the tube 133 and the magnetic resin sealer 134, whereby it is possible to suppress the voltage generated in the pickup coil 12 from being reduced due to manufacturing variations of the magnetic wires 11.

Moreover, since the magnetic wires 11 are not in contact with one another with only the both ends of the magnetic wires 11 being magnetically connected, an aspect ratio of each of the magnetic wires 11 is similar to that in the case of one magnetic wire 11. Therefore, the power generating element 10 according to the second embodiment can obtain a power generating effect by magnetization reversal using the plurality of the magnetic wires 11 while reducing the magnitude of the diamagnetic field,

Note that although the configuration has been described in which the ends of the magnetic wires 11 are magnetically connected to one another by the magnetic resin sealer 134, the ends of the magnetic wires 11 may be magnetically connected to one another by a magnetic metal tape bringing the ends of the magnetic wires 11 together. In addition, the magnetic connector 13 according to the second embodiment may be configured in which the magnetic tube 131 and the resin sealer 132 are included as in the first embodiment, and the magnetic wires 11 are spaced from one another and are each in contact with the magnetic tube 131.

### Third Embodiment

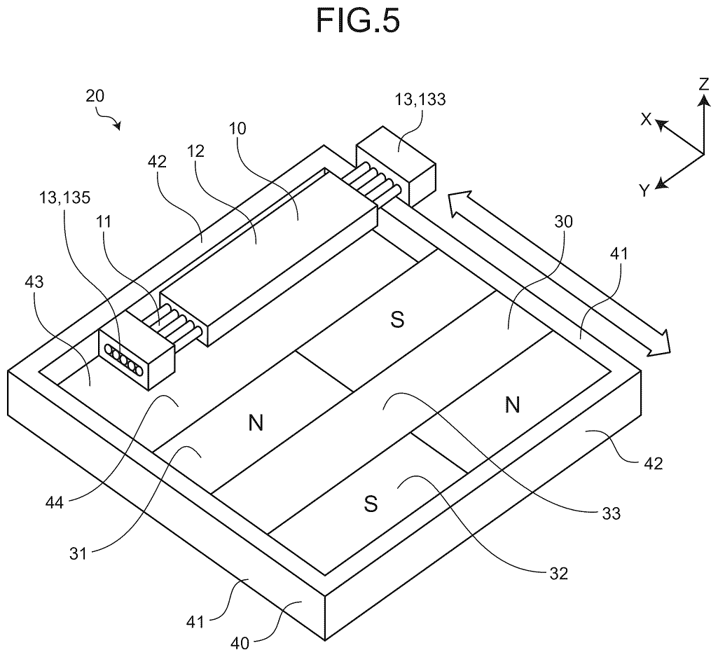

FIG. 5 is a perspective view illustrating a configuration of a power generating module according to a third embodiment. A power generating module 20 according to the third embodiment includes the power generating element 10, a magnetizer 30, and a housing 40. The power generating element 10 includes a plurality of the magnetic wires 11, the pickup coil 12 wound around the magnetic wires 11, and the magnetic connectors 13 disposed at the both ends of the magnetic wires 11. The magnetic connector 13 includes the tube 133 and a magnetic metal tape 135 wrapped around the ends of the magnetic wires 11. An example of the magnetic metal used as a material of the magnetic metal tape 135 includes permalloy, but the material of the magnetic metal tape 135 may be a magnetic metal other than permalloy. The ends of the magnetic wires 11 around which the magnetic metal tape 135 is wrapped are inserted into the tube 133. The plurality of the magnetic wires 11 are arranged side by side in an X direction that is a direction perpendicular to a Y direction as a longitudinal direction. Note that a direction orthogonal to both the X direction and the Y direction is defined as a Z direction. Here, the Y direction is a first direction, and the X direction is a second direction.

The magnetizer 30 includes a first magnet 31 and a second magnet 32 arranged side by side in the X direction. The first magnet 31 and the second magnet 32 are formed of permanent magnets. Between the first magnet 31 and the second magnet 32, a spacer 33 formed of a non-magnetic material is disposed. The non-magnetic material is a substance having relative permeability of one or less.

The first magnet 31, the second magnet 32, and the spacer 33 are integrally fixed to constitute the magnetizer 30. A method of fixing the first magnet 31, the second magnet 32, and the spacer 33 includes bonding, integral molding, screwing, fastening with a fastening band, and the like, for example, but is not limited thereto.

In the magnetizer 30, the first magnet 31 and the second magnet 32 can be integrally displaced in the X direction while maintaining a certain distance therebetween in the X direction. Note that if the first magnet 31 and the second magnet 32 can be integrally displaced in the X direction while maintaining a certain distance therebetween in the X direction, the spacer 33 may be air.

The housing 40 is formed of a non-magnetic material, more specifically, a resin molded body. The housing 40 includes a bottom plate 43 parallel to an XY plane, a pair of frame portions 41 located at both ends, in the Y direction, of the bottom plate 43, and a pair of frame portions 42 located at both ends, in the X direction, of the bottom plate 43. The magnetizer 30 is held in a recess 44 surrounded by the frame portions 41 and 42 and the bottom plate 43.

A width of the recess 44 in the X direction, that is, a distance between the frame portions 42 in the X direction is larger than a width of the magnetizer 30 in the X direction. Therefore, the magnetizer 30 can be displaced in the X direction in the recess 44.

The amount of displacement of the magnetizer 30 is twice or more the distance between the first magnet 31 and the second magnet 32. Also, a movement of the magnetizer 30 in a +Z direction is restricted by a guide portion (not illustrated) protruding in the shape of eaves from the frame portions 41 and 42 to the recess 44.

The power generating element 10 is disposed in the +Z direction with respect to the range in which the magnetizer 30 can be displaced. FIG. 5 illustrates a state in which the first magnet 31 faces the power generating element 10. When the magnetizer 30 is displaced in a +X direction, the second magnet 32 faces the power generating element 10. That is, by a linear movement of the magnetizer 30, the magnetic pole applied to the power generating element 10 is switched. At the time of a change from the state in which the first magnet 31 faces the power generating element 10 to the state in which the second magnet 32 faces the power generating element 10, the magnetic field applied to the magnetic wires 11 is reversed, and a voltage is generated in the pickup coil 12. Similarly, at the time of a change from the state in which the second magnet 32 faces the power generating element 10 to the state in which the first magnet 31 faces the power generating element 10, the magnetic field applied to the magnetic wires 11 is reversed, and a voltage is generated in the pickup coil 12.

In the power generating module 20 according to the third embodiment, the magnetic wires 11 are arranged side by side in the X direction, so that the distance between each of the magnetic wires 11 and the magnetizer 30 in the 2 direction is the same. Therefore, the timings of power generation of the magnetic wires 11 are less likely to vary, and the voltage generated in the pickup coil 12 is less likely to be reduced. Note that the power generating module 20 may be configured using the power generating element 10 according to the first embodiment or the second embodiment.

The power generating module 20 according to the third embodiment can suppress the voltage generated in pickup coil 12 from being reduced due to the manufacturing variations of the magnetic wires 11, and thus can increase the voltage generated in pickup coil 12 when the magnetizer 30 is displaced in the X direction due to vibration or the like.

Note that the magnetic connector 13 according to the third embodiment has the configuration including the tube 133 and the magnetic metal tape 135, but may have a configuration including the magnetic tube 131 and the resin sealer 132 as in the first embodiment, or may have a configuration including the tube 133 and the magnetic resin sealer 134 as in the second embodiment.

### Fourth Embodiment

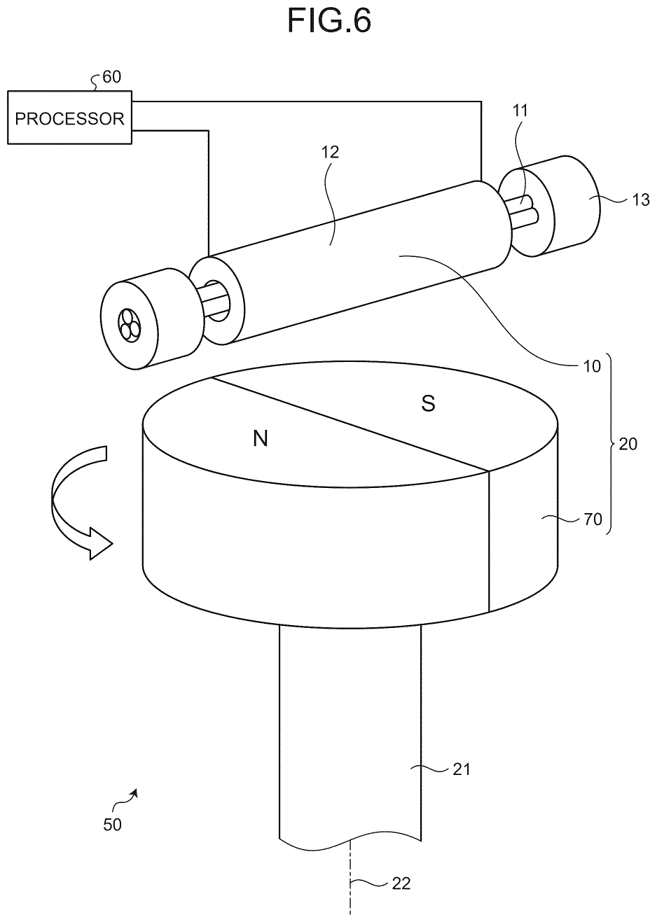

FIG. 6 is a perspective view illustrating a configuration of a rotation speed detector according to a fourth embodiment. A rotation speed detector 50 according to the fourth embodiment is a magnetic rotation speed detector that detects a rotation speed of a rotating body based on an induced voltage generated in accordance with a change in a magnetic field. The rotation speed detector 50 detects the number of times the rotating body rotates per unit time. The rotation speed detector 50 includes the power generating module 20 and a processor 60. The power generating module 20 includes the power generating element 10 according to the first embodiment or the second embodiment, and a magnetizer including a magnet 70 disposed to face the power generating element 10. The magnet 70 is attached to a shaft 21 and rotates with the shaft 21. By a rotational movement of the magnetizer including the magnet 70, the magnetic pole applied to the power generating element 10 is switched. The power generating element 10 generates the induced voltage in the pickup coil 12 in accordance with the change in the magnetic field due to the rotation of the magnet 70. A signal of the voltage generated in the pickup coil 12 is input to the processor 60.

The processor 60 counts the number of pulses of power generation based on the signal input from the power generating element 10. The processor 60 detects the rotation speed of the shaft 21 by counting the number of pulses. The processor 60 can operate using the induced voltage and thus can detect the rotation speed of the shaft 21 without a power supply.

The power generating element 10 is disposed to face the magnet 70 in a direction parallel to an axis of rotation 22 of the shaft 21. The power generating element 10 faces a surface of the magnet 70, the surface being opposite to a surface fixed to the shaft 21. The power generating element 10 may be disposed to face the surface of the magnet 70, the surface being fixed to the shaft 21.

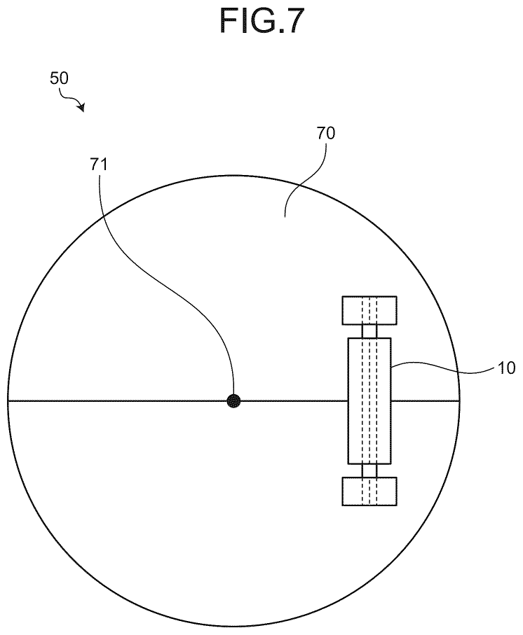

FIG. 7 is a plan view illustrating the magnet and the power generating element included in the rotation speed detector according to the fourth embodiment. FIG. 7 illustrates the rotation speed detector 50 in which the magnet 70 and the power generating element 10 are viewed in the direction parallel to the axis of rotation 22 and from the side opposite to the shaft 21. Note that in FIG. 7, the processor 60 is not illustrated. The power generating element 10 is disposed to face the magnet 70 at a position away from a center 71 of a circle that is a planar shape of the magnet 70. Note that the rotation speed detector 50 is generally used together with an angle detector that detects an angle of rotation of the rotating body. The angle detector includes a disk for optical detection in which an optical slit is formed, a light emitting unit that generates light, and a light receiving unit that detects light emitted from the light emitting unit and passing through the optical slit. For example, the disk is fixed to the rotating body on an upper surface side of the magnet 70. The light emitting unit and the light receiving unit are provided at positions facing the optical slit. In FIG. 7, the angle detector is not illustrated.

The rotation speed detector 50 according to the fourth embodiment can suppress the voltage generated in pickup coil 12 from being reduced due to the manufacturing variations of the magnetic wires 11, and thus can increase the voltage generated in pickup coil 12 by the rotation of the shaft 21.

### Fifth Embodiment

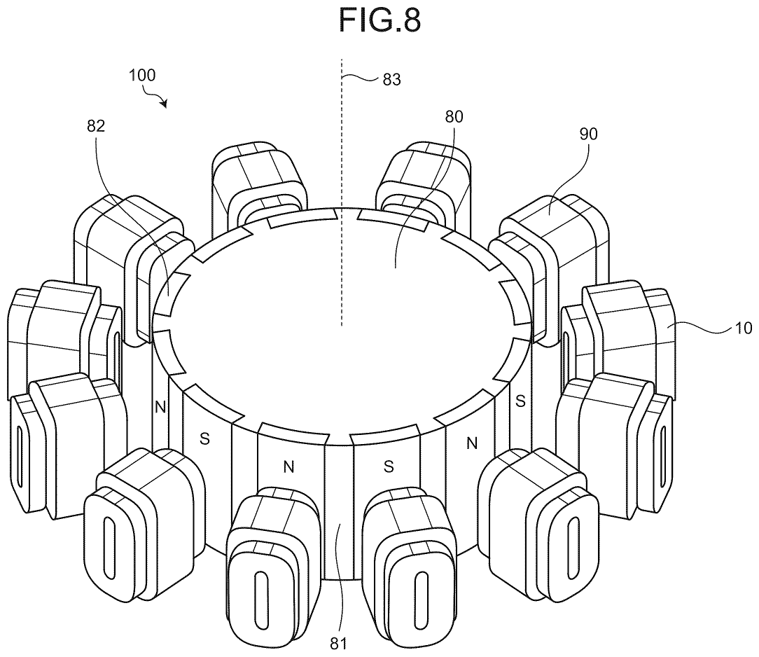

FIG. 8 is a perspective view illustrating a configuration of a power generator according to a fifth embodiment. A power generator 100 according to the fifth embodiment includes a rotor 80 and a stator 90. The rotor 80 includes a base 81 having a columnar shape and a plurality of magnets 82 disposed on an outer peripheral surface of the base 81. The plurality of the magnets 82 are disposed such that the magnet 82 with an N pole facing outward and the magnet 82 with an S pole facing outward alternate in a circumferential direction of the base 81. The stator 90 includes a plurality of the power generating elements 10 disposed on a single arc centered on a central axis of rotation 83 of the rotor 80. The plurality of the power generating elements 10 are installed at equal angular intervals. In the fifth embodiment, 12 pieces of the power generating elements 10 are disposed at intervals of 30 degrees.

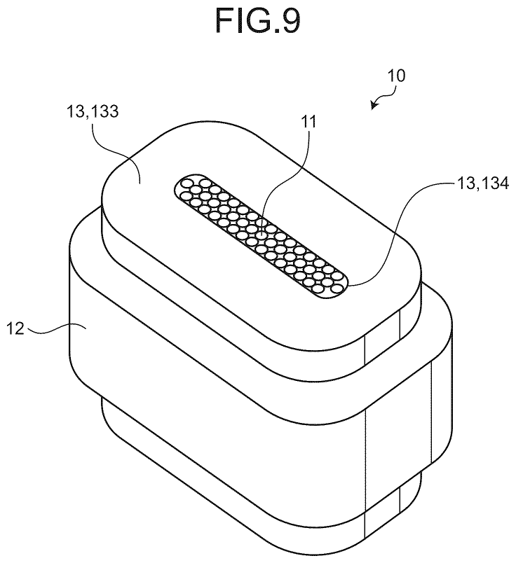

FIG. 9 is a perspective view illustrating a configuration of the power generating element included in the stator of the power generator according to the fifth embodiment. The power generating element 10 includes a plurality of the magnetic wires 11, the pickup coil 12 wound around the plurality of the magnetic wires 11, and the magnetic connectors 13 disposed at the both ends of the magnetic wires 11. The magnetic connector 13 includes the tube 133 and the magnetic resin sealer 134 with which the inside of the tube 133 is filled. In the fifth embodiment, the power generating element 10 included in the stator 90 of the power generator 100 has a configuration similar to that of the power generating element 10 according to the second embodiment, but the number of the magnetic wires 11 is larger than that of the power generating element 10 according to the second embodiment and is typically in two digits to three digits. However, the number of the magnetic wires 11 may be in one digit or four digits or higher, and is not limited to a specific number. As with the power generating element 10 according to the second embodiment, the magnetic resin sealer 134 is present among the ends of the magnetic wires 11 so that the ends of the magnetic wires 11 are magnetically connected to one another.

The magnets 82 of the rotor 80 are magnetized so as to generate lines of magnetic force penetrating the pickup coils 12. When the rotor 80 rotates, the power generating elements 10 are alternately switched between a state of facing the N pole and a state of facing the S pole, so that an alternating current voltage is generated in the pickup coils 12.

In a general power generator, in order to efficiently generate power with respect to rotation of magnets, an iron core as a magnetic material having a high permeability is often placed in a winding. The power generator 100 according to the fifth embodiment uses a bundle of the magnetic wires 11 instead of the iron core, thereby being able to obtain a voltage higher than that of the general power generator by the amount of power self-generated by the magnetic wires 11 undergoing magnetization reversal.

Note that, here, the example has been described where the stator 90 includes the power generating element 10 having the similar structure to the power generating element 10 according to the second embodiment, but the power generating element 10 included in the stator 90 may have a structure similar to that of the power generating element 10 according to the first embodiment.

The configurations illustrated in the above embodiments each merely illustrate an example, and can thus be combined with another known technique or partially omitted and/or modified without departing from the scope of the present disclosure.

### REFERENCE SIGNS LIST

10 power generating element; 11 magnetic wire; 12 pickup coil; 13 magnetic connector; 20 power generating module; 21 shaft; 22 axis of rotation; 30 magnetizer; 31 first magnet; 32 second magnet; 33 spacer; 40 housing; 41, 42 frame portion; 43 bottom plate; 44 recess; 50 rotation speed detector; 60 processor; 70, 82 magnet; 71 center; 80 rotor; 81 base; 83 central axis of rotation; 90 stator; 100 power generator; 131 magnetic tube; 132 resin sealer; 133 tube; 134 magnetic resin sealer; 135 magnetic metal tape.

1. A power generating element comprising:
a plurality of magnetic wires having a large Barkhausen effect;
a pickup coil wound around a bundle of the plurality of the magnetic wires; and
magnetic connectors adapted to magnetically connect ends of the plurality of the magnetic wires at both ends of the plurality of the magnetic wires.

2. The power generating element according to claim 1, wherein, in the plurality of the magnetic wires:
only the both ends are magnetically connected to each other; and
portions other than the both ends are not in contact with each other.

3. The power generating element according to claim 1, wherein the magnetic connectors each includes:
a magnetic tube and a resin sealer with which inside of the magnetic tube is filled; and
each of the plurality of the magnetic wires is in contact with the magnetic tube.

4. The power generating element according to claim 3, wherein
the resin sealer is adapted to fix the ends of the plurality of the magnetic wires such that the magnetic wires expand and contract due to magnetostriction in response to a change in an applied magnetic field.

5. The power generating element according to claim 1, wherein
the magnetic connectors each includes a tube and a magnetic resin sealer with which inside of the tube is filled; and
the magnetic resin sealer is present between the ends of the plurality of the magnetic wires.

6. The power generating element according to claim 5, wherein
the magnetic resin sealer is adapted to fix the ends of the plurality of the magnetic wires such that the magnetic wires expand and contract due to magnetostriction in response to a change in an applied magnetic field.

7. The power generating element according to claim 1, wherein
the magnetic connectors are each a magnetic metal tape wrapped around the ends of the plurality of the magnetic wires.

8. A power generating module comprising:
the power generating element according to claim 1; and
a magnetizer adapted to perform a rotational movement or a linear movement so that a magnetic pole applied to the power generating element is switched, wherein
the power generating element is adapted to generate power by the rotational movement or the linear movement of the magnetizer.

9. The power generating module according to claim 8, wherein
the plurality of the magnetic wires are disposed side by side in a second direction that is a direction perpendicular to a first direction as a longitudinal direction, and
the magnetizer includes a plurality of magnets disposed side by side and apart from each other along the second direction.

10. A rotation speed detector comprising:
the power generating element according to claim 1;
a magnetizer adapted to perform a rotational movement so that a magnetic pole applied to the power generating element is switched; and
a processor adapted to count a pulse due to a voltage generated in the pickup coil by the rotational movement of the magnetizer.

11. A power generator comprising:
a rotor including a base having a columnar shape and a plurality of magnets disposed on an outer peripheral surface of the base; and
a stator in which the power generating elements according to claim 1 are disposed at equal angular intervals on a single arc centered on a central axis of rotation of the rotor, wherein
the plurality of the magnets are disposed such that the magnet with an N pole facing outward and the magnet with an S pole facing outward alternate in a circumferential direction of the base.
